(19) United States
(12) Patent Application Publication
(10) Pub. No.: US 2025/0242449 A1
(43) Pub. Date: Jul. 31, 2025

(54) MECHANICAL DEVICE FOR SUPPLYING RAW MATERIALS FOR METAL ADDITIVE MANUFACTURING AND PROCESSING

(71) Applicant: Shanghai University of Engineering Science, Shanghai (CN)

(72) Inventors: YANHUI LIU, Shanghai (CN); JUN LI, Shanghai (CN)

(21) Appl. No.: 18/915,930

(22) Filed: Oct. 15, 2024

(30) Foreign Application Priority Data
Jan. 31, 2024 (CN) 202410131981.7

(51) Int. Cl. B23K 37/04; B23K 26/342; B33Y 40/10

(52) U.S. Cl. CPC B23K 37/0408; B23K 26/342; B33Y 40/10

(57) ABSTRACT

The present disclosure provides a mechanical device for supplying raw materials for metal additive manufacturing and processing, including a material storage system, a traction system, a fastening system, a preheating system and a control system. Preheating, laying, post-processing cleaning, and leveling of specific additive manufacturing raw materials can be achieved using a mechanical device designed by the present disclosure.

### CROSS-REFERENCE TO RELATED APPLICATION

This application claims priority of Chinese Patent Application No. 202410131981.7, filed on Jan. 31, 2024, the entire contents of which are incorporated herein by reference.

### TECHNICAL FIELD

The present disclosure relates to a mechanical device for supplying raw materials for metal additive manufacturing and processing, falling within the field of modern advanced manufacturing technology.

### BACKGROUND

With the development of modern advanced manufacturing technology, the equipment and technology of additive manufacturing have gradually matured and the performance and quality of additive manufacturing products have been gradually improved on the basis of extensive scientific research and engineering application verification. As an advanced production technology for processing and manufacturing high-end metal parts, additive manufacturing technology has been well known and accepted.

However, currently widely used additive manufacturing technology for metal parts can only use spherical metal powder with a certain particle size to ensure the reliability of powder laying and the uniformity of powder layer thickness, and ensure the stability of the performance and quality of additive manufacturing products. This technology not only has the limitations of high cost of metal powder, slow powder laying speed, complex technology and single metal powder component, but also has the potential hazards of metal dust pollution and harm to staff health (including cleaning a manufacturing chamber and recycling old powder after additive manufacturing).

At present, the manufacturing technology of metal foil is increasingly mature. The foils of stainless steel, aluminum alloy, titanium alloy, nickel alloy, copper alloy, cobalt alloy, molybdenum, niobium, tantalum, zirconium and other metal materials have become mature commercial products, the thickness is uniform and precisely controllable, and the minimum thickness is close to 1 micron. Compared with metal powder, metal foil is used for additive manufacturing, which has the advantages of precise processing layer thickness, low laying technical difficulty, high speed, low raw material cost and high product quality, and avoids the potential safety hazard of metal dust to the environment and human body. In addition, the composite material with precise and controllable changes in composition gradient or performance gradient can be manufactured by exchanging the material and thickness of foil for the current processing layer. The present disclosure provides a mechanical device for supplying raw materials for metal additive manufacturing and processing that is capable of additive manufacturing using metal foil as a raw material.

### SUMMARY

The present disclosure provides a mechanical device for supplying raw materials for metal additive manufacturing and processing. The device uses metal foil as a raw material to replace corresponding metal powder used for additive manufacturing. A mechanical mechanism is employed to pull and lay the foil with a specific thickness, and compacts the laid metal foil to perform additive manufacturing. After the additive manufacturing and processing of a current layer is completed, push-scrape cleaning and cold-pressing leveling are performed on a surface of the current processed layer by the mechanical mechanism, and the metal foil of next layer continues to be laid, the material and thickness of the metal foil of the next layer are variable, and the metal foil can be preheated at an appropriate temperature.

According to the above-mentioned functional description, the device includes a base plate, a material storage system, a heating system, a traction system, a fastening system, a control system, and an additive manufacturing and processing system, and a schematic structural diagram is shown in an accompanying drawing of the specification. The material storage system is configured with two material storage bins by default, and the material storage bins can be increased to no more than five according to needs, each of which is only capable of storing a rolled foil or strip, and the material storage bins can be alternately switched to working positions under the control of the control system. The heating system is attached to each of the material storage bins to preheat the foils or strips stored in the material storage bins. A function of the traction system is to pull the rolled foils or strips out of the storage bins in the working positions, haul and lay flat the rolled foils or strips on a base plate or a processed surface in an additive manufacturing and processing chamber, and tension the same. A function of the fastening system is to fix the foils or strips on the base plate, clean splashes and residues on the processing surface after additive manufacturing processing, and perform cold-pressing on the processed surface to improve the flatness of the processing surface. The additive manufacturing processing system processes the foils or strips in a fixed state. The material storage system, the heating system, the traction system, the fastening system and the additive manufacturing and processing system are controlled by the control system to work in sequence and reset after completing specified functions.

The mechanical device using metal foil as a raw material provided in the present disclosure is applicable to additive manufacturing and processing using energy sources including a laser beam, an electron beam, a plasma beam, an electric arc, and a radiant heat arc, and is applicable to additive manufacturing and processing under environmental conditions including vacuum, controllable atmosphere and air.

The advantages of the present disclosure are as follows. The metal foil is used for additive manufacturing, which has the advantages of precise processing layer thickness, low laying technology difficulty, high speed, low raw material cost and high product quality, and no potential safety hazard of metal dust to the environment and human body. In addition, the material and thickness of the foil for the current processing layer can be exchanged very quickly and simply, and the composite material with precise and controllable changes in composition gradient or performance gradient can be manufactured.

### BRIEF DESCRIPTION OF THE DRAWINGS

FIG. 1 is a schematic structural diagram of a feeding device for metal foil in additive manufacturing according to the present disclosure.

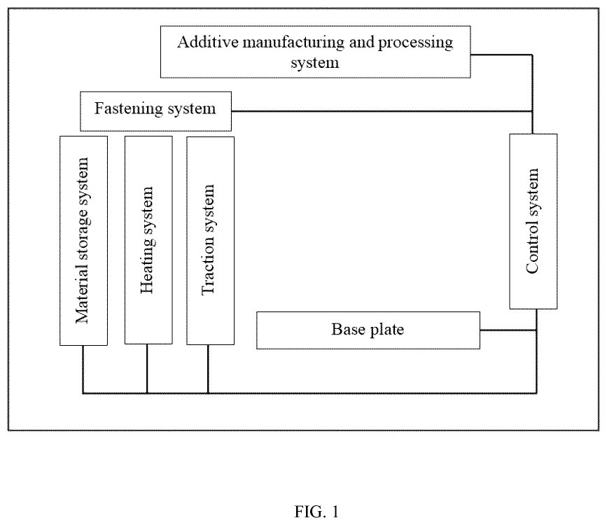

### DETAILED DESCRIPTION

Specific Example 1: (1) aluminum foil with a thickness of 0.02 mm purchased in the market is loaded into a material storage system of a mechanical device; (2) a paper end of the aluminum foil is clamped at a locking mechanism of an outlet of the material storage system; (3) an additive manufacturing and processing chamber is closed and evacuated, and a control switch is turned on; (4) the material storage system enters a working state from a stationary state; (5) the material storage system preheats the aluminum foil; (6) the material storage system supplies the aluminum foil to a traction system; (7) the traction system clamps the aluminum foil and lays the same flat on a flat base plate; (8) the aluminum foil is locked by the material storage system; (9) the traction system tensions the aluminum foil; (10) a fastening system moves to a set position and descends to press the aluminum foil around an additive manufacturing processing area; (11) the material storage system cuts off the aluminum foil from the outlet; (12) a laser head works to complete the additive manufacturing and processing of the aluminum foil; (13) the fastening system is raised and translated, and a scraper and a brush on the fastening system clean splashes and residues on a processing surface; (14) the fastening system performs cold-pressing on the processing area; (15) the fastening system is restored to an initial position; (16) the traction system is restored to an initial position; and (17) the material storage system supplies the aluminum foil to the traction system; and the additive manufacturing and processing for a next layer is performed in sequence of steps (7)-(17).

Specific Example 2: (1) aluminum foil with a thickness of 0.02 mm and nickel foil with a thickness of 0.08 mm purchased in the market are used as raw materials, and are respectively loaded into a material storage system 1 and a material storage system 2 of a mechanical mechanism; (2) paper ends of the nickel foil and aluminum foil are clamped at a locking mechanism corresponding to outlets of the material storage systems; (3) an additive manufacturing and processing chamber is closed and evacuated, and a control switch is turned on; (4) the material storage system 1 enters a working state from a stationary state; (5) the material storage system 1 preheats the aluminum foil, and the material storage system 2 preheats the nickel foil; (6) the material storage system 1 supplies the aluminum foil to a traction system; (7) the traction system clamps the aluminum foil and lays the same flat on a flat base plate; (8) the aluminum foil is locked by the material storage system 1; (9) the traction system tensions the aluminum foil; (10) a fastening system moves to a set position and descends to press the aluminum foil around an additive manufacturing and processing area; (11) the material storage system 1 cuts off the aluminum foil from the outlet; (12) a laser head works to complete the additive manufacturing and processing of aluminum foil; (13) the fastening system is raised and translated, and a scraper and a brush on the fastening system clean splashes and residues on a processing surface; (14) the fastening system performs cold-pressing on the processing area; (15) the fastening system is restored to an initial position; (16) the traction system is restored to an initial position; (17) a mechanical device switches the material storage system 1 to the material storage system 2, and (18) the material storage system 2 supplies the nickel foil to the traction system, and the nickel foil is subjected to the additive manufacturing and processing for a next layer in sequence of steps (7)-(16); and the mechanical device switches the material storage system 2 to the material storage system 1, and the aluminum foil is subjected to the additive manufacturing and processing for a third layer in sequence of steps (7)-(16).

1. A mechanical device for supplying raw materials for metal additive manufacturing and processing,
a mechanical device comprising a material storage system, a traction system, a fastening system, a preheating system and a control system, using a metal foil as raw materials to supply processing raw materials for a metal additive manufacturing system, and having functions of preheating the raw materials and replacing the raw materials during processing.

2. The mechanical device according to claim 1, wherein the metal foil in the material storage system is clamped and drawn by the traction system and laid on a base plate or a workpiece with finished additive manufacturing and processing on a previous layer, and tensioned by the traction system and compacted by the fastening system; the metal foil is cut off at an outlet of the material storage system, and additive manufacturing is performed by energy sources comprising a laser, an electron beam and an ion beam according to appropriate process parameters; and after the additive manufacturing and processing of materials of current layer is completed, the traction system is reset to the outlet of the material storage system, the material storage system supplies the metal foil, the traction system clamps the metal foil and prepares to lay a next layer, and the fastening system performs push-scrape cleaning and cold-pressing leveling on a surface of the current layer.

3. The mechanical device according to claim 1, wherein the raw materials used are rolled strip metal foil with a foil thickness between 1.00 mm and 0.001 mm.

4. The mechanical device according to claim 1, wherein the material storage system has a function of replacing the material and thickness of the next layer of additive manufacturing foil relative to the metal foil used in the current layer of additive manufacturing.

5. The mechanical device according to claim 1, wherein the material storage system has the function of preheating the metal foil.
